(19) United States
(12) Patent Application Publication
(10) Pub. No.: US 2004/0096306 A1
(43) Pub. Date: May 20, 2004

(54) Device at lift trucks

(75) Inventor: Hans Carlsson, Ljungby (SE)

Correspondence Address: TAROLLI, SUNDHEIM, COVELL, & TUMMINO L.L.P., Suite 1111, 526 SUPERIOR AVENUE, CLEVELAND, OH, 44114-1400, US

(73) Assignee: SMV Liftrucks AB

(21) Appl. No.: 10/607,354

(22) Filed: Jun. 26, 2003

(30) Foreign Application Priority Data
Jul. 3, 2002 (SE) 0202054-3

(51) Int. Cl. B66C 23/00

(52) U.S. Cl. 414/685

(57) ABSTRACT

The present invention relates to a device at lift trucks, comprising a chassis (3) with a driving compartment (2) and a lifting device (9) for lifting goods. The lifting device (9) has two lifting arms (15, 16) of which rear portions (15a, 16a) are provided on the chassis (3) behind the driving compartment (2) by means of linkages (19, 20) which permit a) pivoting of the lifting arms (15, 16) by means of lifting units (22, 23) in vertical planes (VP15, VP16) for moving goods in vertical directions and b) pivoting of the lifting arms (15, 16) by means of pivoting devices (28, 29) in horizontal planes (HP15, HP16) between inner positions (IL) in which the distance (Min) between their front portions (15b, 16b) or front tips (17e, 18e) of lifting means (17, 18) provided on said front portions (15b, 16b) is less than front portions of the chassis (3), and outer positions (YL) in which the distance (Max) between their front portions (15b, 16b) or between said front tips (17e, 18e) is greater than the width (B) of said front portions of the chassis (3).

The present invention relates to a device at lift trucks, comprising a chassis with a driving compartment and a lifting device for lifting goods, wherein the lifting device has two lifting arms of which rear portions are provided on the chassis behind the driving compartment by means of linkages which permit pivoting of the lifting arms by means of lifting units in vertical planes for moving goods in vertical directions, and pivoting of the lifting arms by means of pivoting devices in horizontal planes for changing the distance and/or the angle between at least such front portions thereof or such lifting means provided on front portions thereof, which are adapted for fetching and delivering goods.

Lift trucks known from U.S. Pat. No. 3,454,176 have vertically pivotable lifting arms which are journalled behind the driving compartment and which are pivotable to some extent in horizontal directions. These lift trucks are said to have an advantageous distribution of the loads on the wheels, a robust and low fork structure and an improved reliability and field of view in forward direction. The field of view in forward direction however, is not particularly improved relative to prior art lift trucks, since the lifting arms are connected to each other at the front by means of a transverse beam, which prevents substantially pivoting thereof out of the field of view of the operator.

The object of the present invention has been to eliminate this problem, which is accomplished by providing the device according to the invention with the characterizing features of primarily subsequent claim 1.

Since the lifting arms are journalled in such linkages and cooperate with such pivoting devices that they are pivotable from adjacent mutual positions in which front portions thereof are located within the chassis to mutual outer positions in which the front portions are situated outside the chassis, it is achieved that the lifting arms on one hand can be set to fetch small loads or reach into narrow spaces in loads to be fetched and on the other hand can be set to give a totally free field of view in forward direction and/or to fetch large or long loads.

The invention will be further described below with reference to the accompanying drawings, in which

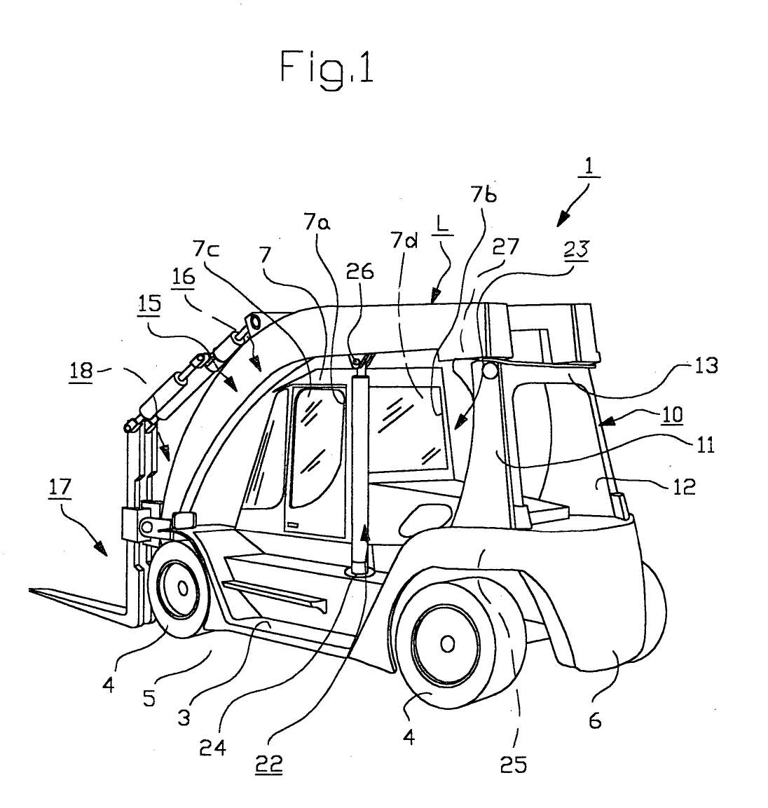

FIG. 1 is a perspective view of a lift truck according to the invention obliquely from behind and with a lifting device located in a lower position;

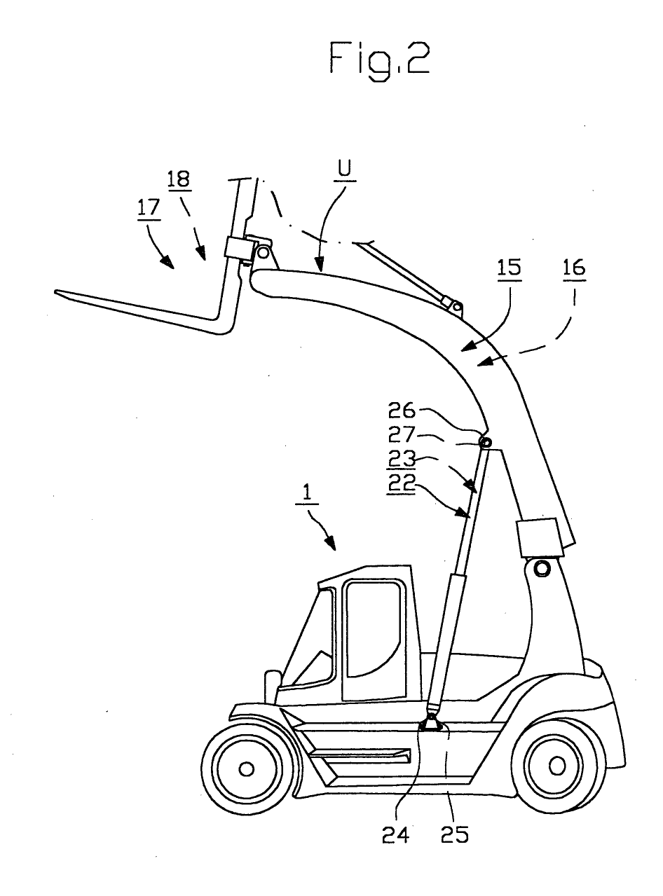

FIG. 2 is a side view of the lift truck of FIG. 1 with the lifting device located in an upper position;

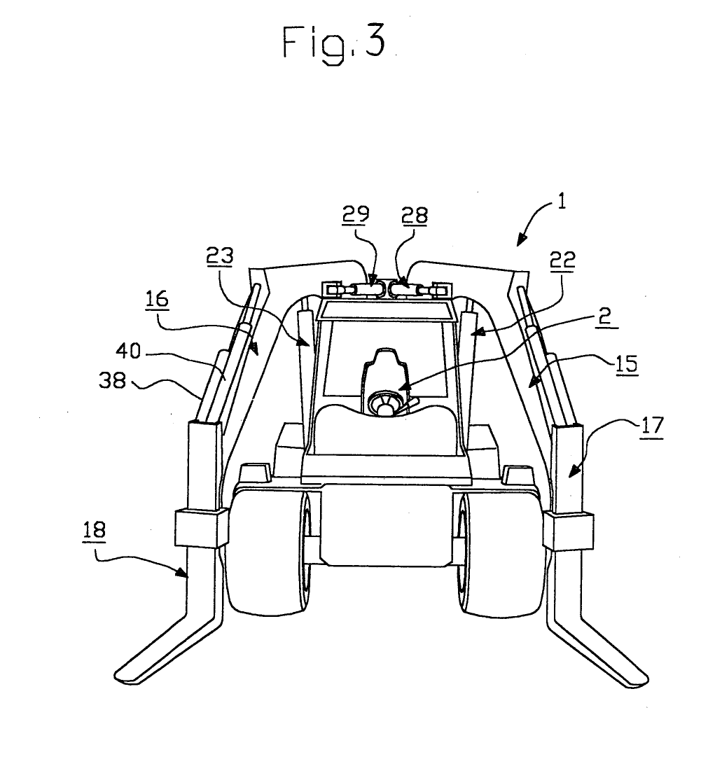

FIG. 3 is a front view of the lift truck of FIG. 1 with lifting arms provided in outwardly pivoted positions relative to each other;

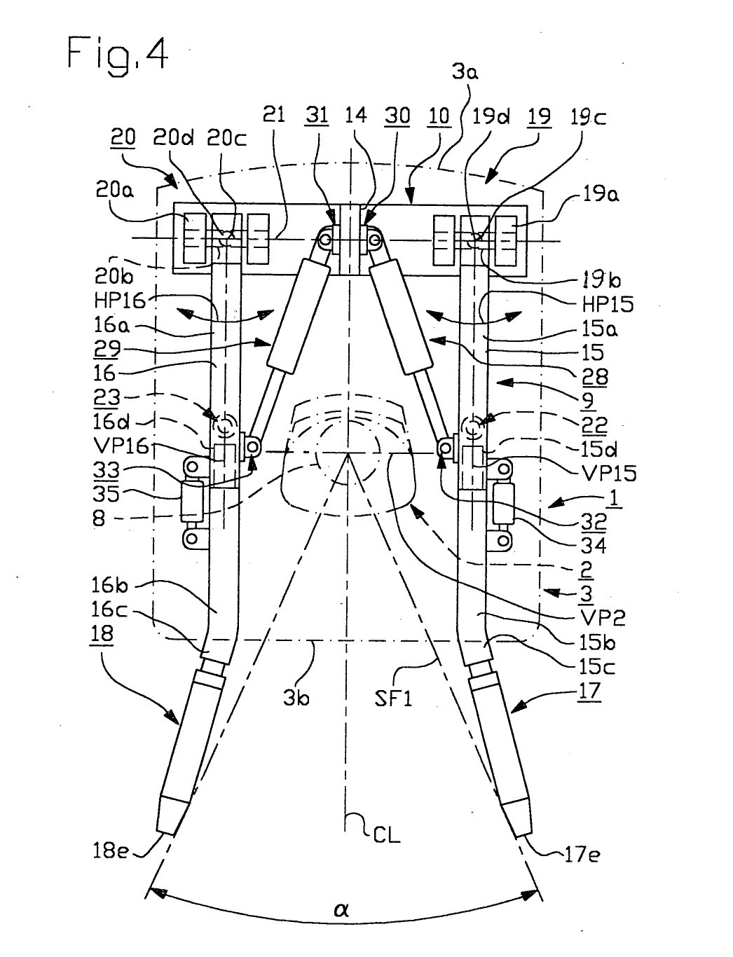

FIG. 4 is a schematic plan view of the lift truck of FIG. 1;

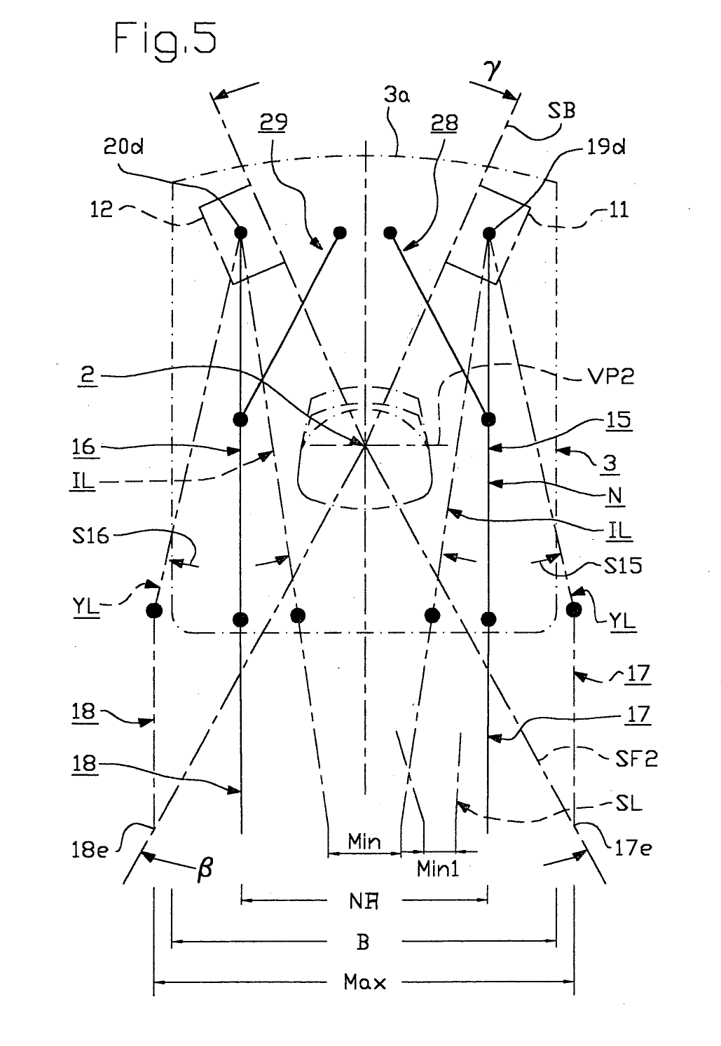

FIG. 5 is a schematic plan view of the lift truck of FIG. 4 with lifting arms forming part thereof in different positions;

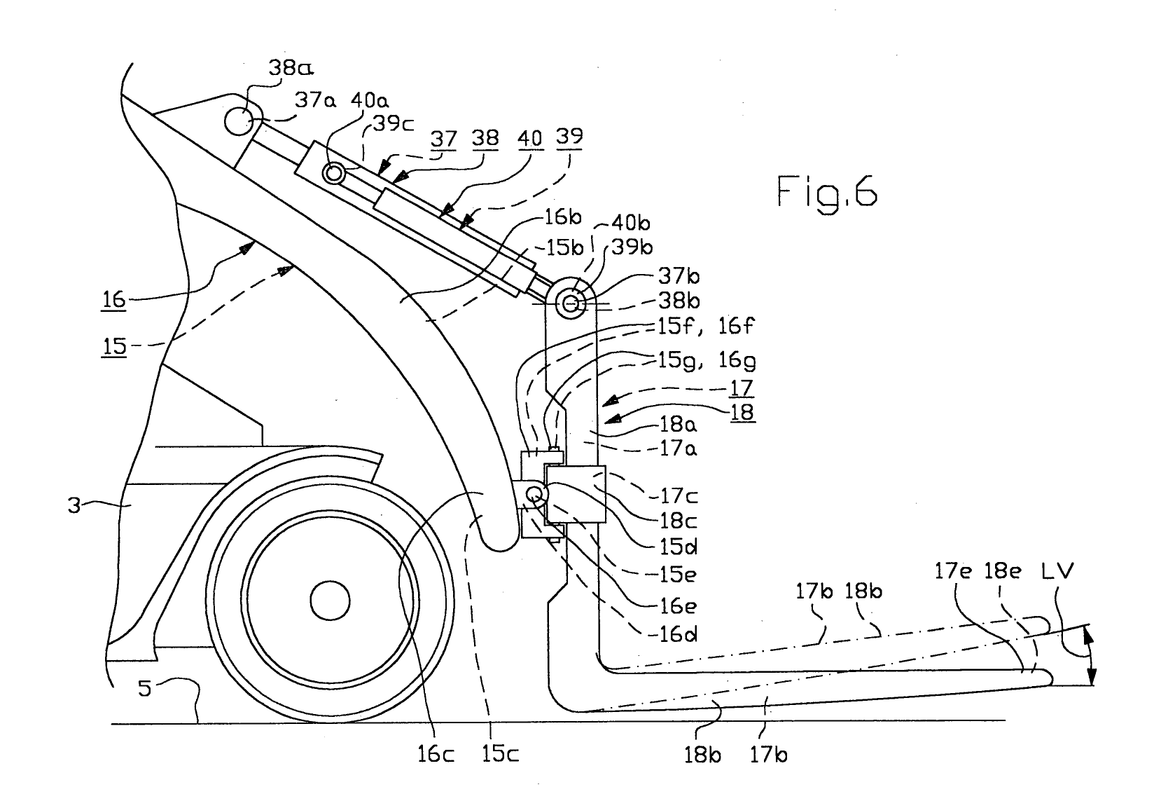

FIG. 6 is a side view of front members of the lift truck of FIG. 1; and

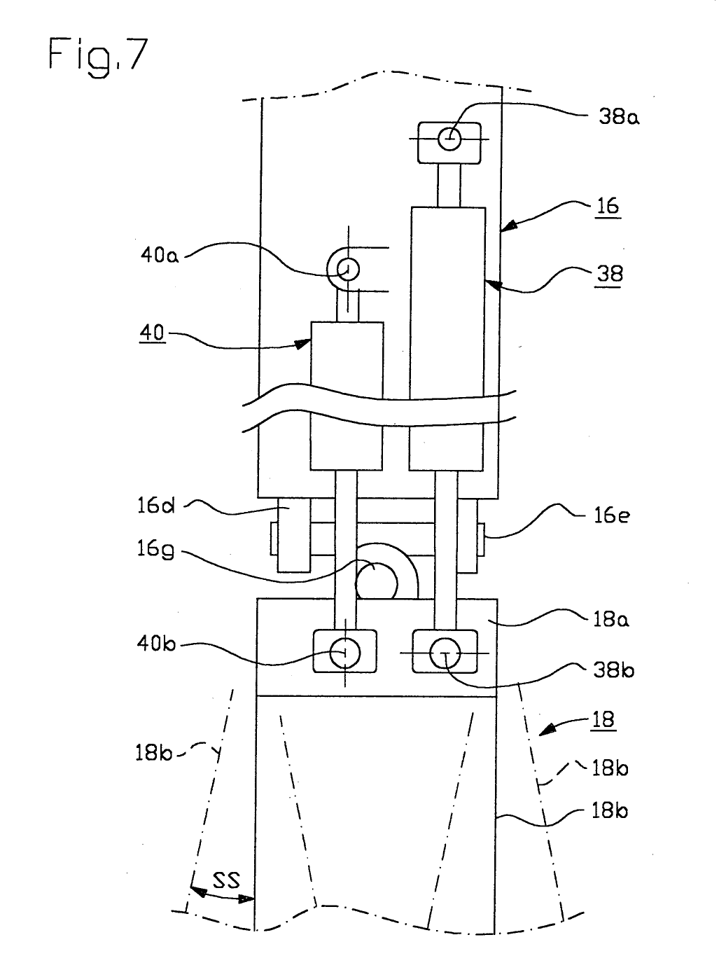

FIG. 7 is a plan view of some of said front members.

The lift truck 1 illustrated in the drawings is a counterweight lift truck with a driving compartment 2. The lift truck 1 comprises a chassis 3 with e.g. four or six driving wheels 4 for driving on a ground 5. Rear portions 3a of the chassis 3 has a driving motor (not shown) for operating the lift truck 1 on the ground 5 and for operating its various control means. The rear portions 3a of the chassis 3 also includes the counterweight 6 of the lift truck 1 and the driving compartment 2 is situated in front of said rear portions 3a. The driving compartment 2 preferably includes an operator's cabin 7 with a seat 8 which is directed or can be directed forwards towards front portions 3b of the chassis 3. When the operator is sitting in the driving compartment 2, he must be able to drive the lift truck 1 and operate a lifting device 9 provided thereon. Thereby, the driver/operator shall have the best possible field of view in forward direction.

The lifting device 9 is adapted to lift goods and is provided on the rear portions 3a of the chassis 3 through a retaining device 10. Said device comprises e.g. two upwardly directed posts 11, 12 which in level with the roof of the operator's cabin 7 or somewhat above said roof are connected to each other by a substantially horizontally directed connecting member 13. The connecting member 13 has in turn a centrally provided bracket 14 which is directed upwards and which preferably is centered with a geometric centre line CL passing centrally along the chassis 3.

The posts 11, 12 are preferably provided on opposite sides of the rear portions 3a of the chassis 3 in order to give the operator a large field of view SB in backwards direction. The posts 11, 12 are preferably inclined in backwards/outwards direction relative to the centre line CL and they can define substantially the same angle γ between them as the field of view SB between said posts.

The lifting device 9 has two lifting arms 15, 16 (jibs) which have substantially straight rear portions 15a, 16a and arcuate, downwardly directed front portions 15b, 16b. When the lifting device 9 is set in lower positions L (see FIG. 1), the rear portions 15a, 16a of the lifting arms 15, 16 are directed substantially horizontally and are found behind or substantially behind a geometric vertical plane VP2 extending through the driving compartment 2 and in transverse direction relative to the centre line CL. The vertical plane VP2 is preferably extending at 90° or substantially 90° relative to the centre line CL. The lifting arms 15, 16 extend in forward direction beyond said vertical plane VP2 and—seen from above towards the lift truck 1—on opposite sides of the driving compartment 2. At least when the lifting device 9 is set in said lower positions L, the lifting arms 15, 16 extend horizontally or substantially horizontally-and front portions 15b, 16b thereof are situated in front of said vertical plane VP2. The front portions 15b, 16b are in said lower positions of the lifting arms 15, 16 directed preferably forward/downwards such that lower parts 15c, 16c of the front portions 15b, 16b can be brought to positions in front of front portions 3b of the chassis 3. Lifting means 17, 18 are provided on said lower parts 15c, 16c and adapted to cooperate with goods for fetching, lifting and delivery. The lifting means 17, 18 can be designed as lift forks.

The lifting arms 15, 16 are provided on the retaining device 10 by means of linkages 19, 20. Each such linkage 19 and 20 respectively, is designed as a two-axled link or similar, allowing the respective lifting arm 15, 16 to-be pivoted in two, preferably perpendicular planes, namely in vertical planes VP15 and VP16 respectively, and horizontal planes HP15 and HP16 respectively (see FIG. 4).

The linkages 19, 20 are preferably provided behind the vertical plane VP2 and they are preferably provided at a distance from each other which, seen from above towards the lift truck 1, is only somewhat less than the width B of the chassis 3. Each linkage 19 and 20 respectively, may e.g. comprise a fork like bearing member 19a and 20a respectively, or similar, having a horizontal through shaft 19b and 20b respectively, on which the rear portions 15a and 16a respectively, of the lifting arms 15 and 16 respectively, are journalled such that they can pivot in said vertical planes VP15 and VP16 respectively, about a horizontal or substantially horizontal geometric line 21 which may be common to both linkages 19, 20. Furthermore, each linkage 19 and 20 respectively, may comprise a vertically directed shaft 19c and 20c respectively, through which the fork like bearing member 19a and 20a respectively, is journalled on the connecting member 13 such that said bearing member can be pivoted about an at least in certain positions vertical geometric line 19d and 20d respectively, whereby the lifting arms 15, 16 can be pivoted in said horizontal planes HP15 and HP16 respectively. The geometric line 19d and 20d respectively, preferably intersects the geometric line 21.

Pivoting of the lifting arms 15 and 16 respectively, in the respective vertical plane VP15, VP16 is carried through by means of lifting units 22 and 23 respectively, which e.g. are shaped as standing cylinder/piston-devices. The lifting units 22, 23 are preferably provided behind the vertical plane VP2 and they are down below journalled on the chassis 3 through lower linkages 24, 25 and on the lifting arms 15, 16 through upper linkages 26, 27. When the lifting device 9 is set in its lower position L, the lifting units 22, 23 are preferably vertically or substantially vertically directed and they are located preferably obliquely behind rear edge posts 7a, 7b of the operator's cabin 7 such that they do not conceal the field of view of the driver/operator when he or she looks out through the side windows 7c, 7d of the operator's cabin 7.

Said lower and upper linkages 24-27 are designed such that they permit the movements between the lifting units 22, 23 and the chassis 3 on one hand and the lifting units 22, 23 and the lifting arms 15, 16 on the other hand, which are required for being able to pivot the lifting arms 15, 16 in said different planes relative to the chassis 3 and to each other. Said linkages 24-27 may e.g. permit movements in general and be designed as ball joints.

The lifting units 22, 23 are provided to pivot the lifting arms 15, 16 in said vertical planes VP15, VP16 between said lower position L of the lifting device 9 and an upper position U thereof (see FIG. 2). Said lifting units 22, 23 can be operated or controlled to pivot the lifting arms 15, 16 simultaneously and in parallel with each other, but it is also possible to temporarily operate or control one of the lifting arms 15 or 16 to pivot individually relative to the other, e.g. for setting the lifting means 17, 18 at different heights if one fetches goods standing on a sloping ground or places goods on sloping ground.

Pivoting of the lifting arms 15, 16 in horizontal planes HP15, HP16 is carried through by means of pivoting devices 28, 29, e.g. cylinder/piston-devices which at the back are mounted on the bracket 14 through rear linkages 30, 31 and at the front through front linkages 32, 33 at the lifting arms 15, 16 in front of the linkages 19, 20. The rear and front or fore linkages 30-33 are designed such that they permit the movements between the bracket 14 and the lifting arms 15, 16 which are necessary for pivoting the lifting arms 15, 16 in said different planes relative to the chassis 3 and to each other. The rear and front linkages 30-33 may e.g. permit movements in general and be designed as ball joints.

In FIG. 5, examples are given of different positions within which and to which the lifting arms 15, 16 can be pivoted about said vertical geometric lines 19d, 20d in horizontal planes by means of the pivoting devices 28, 29. Thus, the lifting arms 15, 16 can be set in such positions N, which can be intermediate positions, in which they are directed essentially in parallel with the longitudinal centre line CL of the lift truck 1 or in which they converge somewhat. In these positions N in which the lifting arms 15, 16 are shown with solid lines, the distance NA between said arms and the lifting means 17, 18 provided thereon may be less than the width B of the lift truck 1. The lifting arms 15, 16 can be set in said intermediate positions N e.g. when the lift truck 1 is driven without goods and the driver thereby has a sufficiently good view in forward direction for driving the lift truck 1.

In certain cases, e.g. when smaller goods shall be fetched or if you need to reach into narrow spaces of if one shall insert the lifting means 17, 18 into paper rolls or similar, the lifting arms 15, 16 can be pivoted from said intermediate positions N in inwards direction towards each other to inner positions IL—shown with broken lines in FIG. 5—such that the least distance Min between their lifting means 17, 18 will be substantially less than the width B of the lift truck 1. In other cases, e.g. if the driver/operator needs a completely free view within a large area in forward direction and/or if large or long goods shall be fetched, the lifting arms 15, 16 can be pivoted outwards from each other to outer positions YL—illustrated with broken lines in FIG. 5—such that the greatest distance Max between them or their lifting means 17, 18 will be greater or substantially greater than the width B of the lift truck 1.

As is apparent from FIG. 1, the lifting arms 15, 16 can be set in different symmetrical positions relative to the centre line CL within their pivoting areas S15, S16, i.e. at the same distance between the lifting means 17, 18 and the centre line CL. It may however also be possible to set the lifting arms 15, 16 such that their lifting means 17, 18 are situated in asymmetrical positions SL relative to the centre line CL. An example of such positions SL, shown on the right hand side of FIG. 5, is that the lifting arms 15, 16 are set such that their lifting means 17, 18 are found on the same side of the centre line CL and e.g. with a small mutual distance, Min 1.

The pivoting devices 28, 29 can be operated or controlled to pivot the lifting arms 15, 16 simultaneously and symmetrically relative to the centre line CL. The pivoting devices 28, 29 may however also be individually operated or controlled in order to bring each lifting arm 15, 16 to perform an individual pivoting movement for setting the lifting arms 15, 16 in said asymmetrical positions SL.

The front portions 15b, 16b of the lifting arms 15, 16 and/or the lifting means 17, 18 provided thereon are preferably inclined in a forward/outwards direction relative to said centre line CL such that they define substantially the same angle β between them as a field of view SF2 for the driver/operator in forward direction, preferably when the lifting arms 15, 16 are situated in such intermediate positions N relative to each other in which they are directed in parallel or substantially in parallel with said centre line CL.

The rear linkages 30, 31 of the pivoting devices 28, 29 are preferably centered or substantially centered with the horizontal or substantially horizontal geometric line 21 about which the lifting arms 15, 16 are pivotable. The rear linkages 30, 31 may however be located further on on the chassis 3, but they are preferably provided behind the vertical plane VP2 through the driving compartment 2.

The front linkages 32, 33 of the pivoting devices 28, 29, through which said pivoting devices 28, 29 are articulately mounted on the lifting arms 15, 16, are preferably provided behind the vertical plane VP2, but may be located further on at said vertical plane VP2 or possibly somewhat in front of said vertical plane.

With the arrangement defined above of the lifting arms 15, 16 and their lifting means 17, 18, the operator gets a field of view in forward direction which is free between the lifting arms 15, 16 and the lifting means 17, 18 and which can be made as large as 120° by setting the lifting arms 15, 16 in their outer positions YL. Because of the location of the posts 11, 12 and their inclination, the operator gets an advantageous free field of view SB in backwards direction, and because the lifting units 22, 23 are located obliquely behind the operator's cabin 7, the operator gets an advantageous free field of view also to the sides.

The length of the lifting arms 15, 16 may be varied by giving them a telescopic structure. Such a structure is shown in FIG. 4 and it may consist of that the front portions 15b and 16b respectively, of each lifting arm 15 and 16 respectively, at the rear have parts 15d and 16d respectively, which displaceably engage the rear portions 15a and 16a respectively. In order to change the length of the lifting arms 15, 16 and maintain the length set after the change, there may be power units 34 and 35 respectively, e.g. cylinder/piston-devices, which at the back are mounted on the respective rear portion 15a, 16a of the lifting arms 15, 16 and at the front on the respective front portion 15b, 16b. The power units 34, 35 may be operated or controlled to change the length of both lifting arms 15, 16 to the same extent and simultaneously, but they may also be individually operated or controlled in order to momentarily change the length of only one of the lifting arms 15, 16 or in order to momentarily change the length of one lifting arm more than the length of the other lifting arm. This individualability to operate or control the power units 34, 35 to make one lifting arm longer than the other, can be used e.g. for fetching tilted goods.

Two lifting units 22, 23 are shown in the drawings, but it is eventually possible to use one such or more than two such lifting units for lifting or raising the lifting arms 15, 16 in the vertical planes VP15, VP16. Furthermore, two pivoting devices 28, 29 are shown in the drawings, but it is eventually possible to use one such or more than two such pivoting devices for pivoting the lifting arms 15, 16 in the horizontal planes HP15, HP16.

As is apparent from FIG. 6 and 7, each lifting means 17, 18 may consist of a lift fork. Each lift fork may comprise a fork shaft 17a and 18a respectively, and a fork blade 17b and 18b respectively. The fork shafts 17a, 18a are provided on the lower parts 15c, 16c of the lifting arms 15, 16. For this purpose, each lower part 15c and 16c respectively, may include flanges 15d and 16d respectively, in which a horizontal shaft 15e and 16e respectively, is provided. A U-shaped link element 15f and 16f respectively, is provided on said horizontal shaft such that it can pivot or rotate about the shaft. A vertically or substantially vertically directed shaft 15g and 16g respectively, is provided on the U-shaped link element 15f and 16f respectively, and a tubular member 17c and 18c respectively, is provided on said shaft such that it can pivot or rotate about the shaft. In each tubular member 17c and 18c respectively, one of the fork shafts 17a and 18a respectively, is longitudinally displaceably mounted.

A first pivoting unit 37 and 38 respectively, is provided on each lifting arm 15, 16 and adapted for pivoting the lift forks about the horizontal shafts 15e, 16e and thereby alter the angle of inclination LV between the fork blades 17b, 18b and the horizontal plane. Each first pivoting unit 37, 38 may be a cylinder/piston-device or similar and is mounted through a link 37a, 38a to the lifting arms 15, 16 and through a link 37b, 38b to upper parts of the fork shaft 17a, 18a. The links 37a, 38a, 37b, 38b may permit movements in general and may be designed as ball joints.

Said first pivoting units 37, 38 can be operated or controlled to pivot the lifting means 17, 18 simultaneously and so that their fork blades 17b, 18b take positions corresponding to each other. The first pivoting units 37, 38 may also be individually operated or controlled to pivot only one of the lifting means 17 or 18 for changing position of only one of the fork blades 17b or 18b or changing position of the lifting means 17, 18 to various extents in order to bring the fork blades 17b, 18b into different positions relative to the horizontal plane.

The fork shafts 17a, 18a can be pivoted about the shafts 15g and 16g respectively, for setting the fork blades 17b, 18b in different positions within a pivoting sector SS relative to the centre line CL. The pivoting of the fork shafts 17a, 18a and thereby, the fork blades 17b, 18b, is carried through by means of second pivoting units 39, 40 provided beside the first pivoting units 37, 38. The second pivoting units 39, 40 may be cylinder/piston-devices or similar and they are connected to the first pivoting units 37, 38 through links 39a, 40a and to the fork shafts 17a, 18a through links 39b, 40b, whereby said links 39a, 40a, 39b, 40b are provided to permit movements in general and thereby, pivoting of the lift forks.

The second pivoting units 39, 40 may be operated or controlled to pivot the lifting means 17, 18 simultaneously and so that their fork blades 17b, 18b take the same angular positions relative to the centre line CL. The second pivoting units 39, 40 may also be operated or controlled to pivot the lifting means individually for changing position of only one of the lifting means 17 or 18 and thereby, the angular position of only one of the fork blades 17b or 18b, or pivot the lifting means 17, 18 differently in order to bring the fork blades 17b, 18b into different angular positions relative to the centre line CL.

Since each lifting means 17 and 18 respectively, is provided on a lifting arm 15 and 16 respectively, instead of on a lifting carriage, such a carriage is not required nor are those vertical beams along which the carriage was movable. This means that many parts and members which previously were found in the field of view of the driver/operator disappear and the construction of the lift truck becomes less complex.

In order to present the best possible field of view to the driver/operator, the lifting arms 15, 16 are preferably provided to permit between them a free or substantially free view for the operator in forward direction when said operator is in the driving compartment 2. The operator's view becomes particularly good if the front portions 15b, 16b of the lifting arms 15, 16 lack connections or in any case lack connections to each other substantially impairing the view.

The lifting arms 15, 16 are preferably also provided to permit between them a free or substantially free view such that the operator of the lift truck 1 from the driving compartment 2 can see front tips 17e, 18e of the lifting means 17, 18 which are provided on the front portions 15b, 16b of the lifting arms 15, 16.

Since the lifting arms 15, 16 lack connections between them, said arms and the retaining device 10 located behind the driving compartment 2 can replace vertical beams located in front of the driving compartment and a lifting carriage provided on said beams.

Preferably, the lifting arms 15, 16 or members located thereon have no connections whatsoever to each other in front of the linkages 19, 20, which in many cases is an advantageous embodiment.

The lifting means 17, 18 may instead of lift forks consist of fetching arms (not shown) for fetching certain goods, e.g. bales or rolls. Eventually, a clamping device—e.g. a cylinder/piston-device—can be located between said fetching arms for clamping or gripping bales or rolls therebetween such that they can be lifted. The lifting means 17, 18 may also be an assembly in the form of a lifting assembly for plate like goods or similar.

In the above description it is stated that axes, lines and planes are horizontal or vertical, but these are desired ideal positions which are true when the lift truck 1 stands on horizontal or substantially horizontal ground 5 and which, depending on different constructions or other factors in reality can deviate up to a few percent and eventually up to 10 percent from said desired ideal positions.

The invention is not limited to the embodiment described above and illustrated in the drawings, but may vary within the scope of the subsequent claims regarding the number, location and function of the various parts and members. It can e.g. be mentioned that the lifting arms 15, 16 may have another shape than shown and they may define or include other types of lifting means for goods than those shown. The linkages 19, 20 may be constructed otherwise than shown and described and yet provide the desired function. It should finally be mentioned that the invention is applicable on other lift trucks than counterweight trucks.

1. Device at lift trucks, comprising a chassis (3) with a driving compartment (2) and a lifting device (9) for lifting goods,
wherein the lifting device (9) has two lifting arms (15, 16) of which rear portions (15a, 16a) are provided on the chassis (3) behind the driving compartment (2) by means of linkages (19, 20) which permit
a) pivoting of the lifting arms (15, 16) by means of lifting units (22, 23) in vertical planes (VP15, VP16) for moving goods in vertical directions, and
b) pivoting of the lifting arms (15, 16) by means of pivoting devices (28, 29) in horizontal planes (HP15, HP16) for changing the distance (NA) and/or the angle (α) between at least such front portions (15b, 16b) thereof or such lifting means (17, 18) provided on front portions (15b, 16b) thereof, which are adapted for fetching and delivering goods, characterized in that the pivoting devices (28, 29) and the linkages (19, 20) permit pivoting of the lifting arms (15, 16) between inner positions (IL) in which the distance (Min) between their front portions (15b, 16b) or front tips (17e, 18e) of lifting means (17, 18) provided on said front portions (15b, 16b) is less than front portions of the chassis (3), and outer positions (YL) in which the distance (Max) between their front portions (15b, 16b) or between said front tips (17e, 18e) is greater than the width (B) of said front portions of the chassis (3).

2. Device according to claim 1, characterized in that front portions (15b, 16b) of the lifting arms (15, 16) in front of the driving compartment (2) lack connections to each other or in any case lack connections to each other substantially impairing the view, such that said front portions (15b, 16b) permit a free or substantially free view for the driver/operator in forward direction.

3. Device according to claim 1 or 2, characterized in that front portions (15b, 16b) of the lifting arms (15, 16) are provided to permit between them a free or substantially free view such that the driver/operator of the lift truck (1) from the driving compartment (2) can see front tips (17e, 18e) of the lifting means (17, 18) which are provided on the front portions (15b, 16b) of the lifting arms (15, 16).

4. Device according to any preceding claim, characterized in that the lifting arms (15, 16) are provided to permit that their front portions (15b, 16b) and preferably front tips (17e, 18e) of lifting means (17, 18) located on said front portions (15b, 16b) are visible from the driving compartment (2) when the lifting arms (15, 16) are set in their inner positions (IL), outer positions (YL) and positions therebetween.

5. Device according to any preceding claim, characterized in that the lifting arms (15, 16) in their positions (IL) have a least distance (Min) between their front portions (15b, 16b) and preferably between said front tips (17e, 18e) which is substantially less than a greatest distance (Max) between their front portions (15b, 16b) and preferably between said tips (17e, 18e).

6. Device according to any preceding claim, characterized in that the lifting arms (15, 16) in intermediate positions (N) between said inner and outer positions (IL, YL) are directed in parallel or substantially in parallel with each other and in parallel or substantially in parallel with a geometric centre line (CL) extending centrally along the chassis (3).

7. Device according to any preceding claim, characterized in that the lifting arms (15, 16) are provided on opposite sides of a geometric centre line (CL) extending centrally along the chassis (3) and that the pivoting devices (28, 29) are operated or controlled to pivot the lifting arms (15, 16) simultaneously and symmetrically relative to said centre line (CL) to such positions in relation thereto that they define the same or substantially the same angle therewith.

8. Device according to any preceding claim, characterized in that the lifting arms (15, 16) are provided on opposite sides of a geometric centre line (CL) extending centrally along the chassis (3) and that the pivoting devices (28, 29) are operated or controlled to pivot the lifting arms (15, 16) simultaneously and assymmetrically relative to said centre line (CL) to such positions that they define different angles therewith.

9. Device according to claim 8, characterized in that the pivoting devices (28, 29) are operated or controlled to pivot the lifting arms (15, 16) to such positions that the front portions (15b, 16b) of said lifting arms (15, 16) and preferably front tips (17e, 18e) of lifting means (17, 18) on said front portions (15b, 16b) are located on the same side of the centre line (CL) and at a small distance (Min 1) from each other.

10. Device according to any preceding claim, characterized in that the lifting arms (15, 16) are pivotable in horizontal planes (HP15, HP16) at least when they are set in lower positions in which they extend horizontally or substantially horizontally.

11. Device according to any preceding claim, characterized in that rear linkages (30, 31) through which the pivoting devices (28, 29) are articulately mounted on the chassis (3) behind a vertical plane (VP2) which extend through the driving compartment (2) and in a transverse direction relative to a geometric centre line (CL) passing centrally through the chassis (3), and that front linkages (32, 33) through which the pivoting devices (28, 29) are articulately mounted on the lifting arms (15, 16), are located behind said vertical plane (VP2), at said vertical plane or at a small distance in front of said plane.

12. Device according to any preceding claim, characterized in that rear and front linkages (30, 31, 32, 33) through which the pivoting devices (28, 29) are articulately mounted on the chassis (3) and on the lifting arms (15, 16), are provided to permit movements in general.

13. Device according to any preceding claim, characterized in that each lifting arm (15 and 16 respectively) is pivotable in a horizontal plane (HP15 and HP16 respectively) about a geometric line (19d and 20d respectively) intersecting a geometric line (21) about which each lifting arm (15 and 16 respectively) is pivotable in a vertical plane (HP15 and HP16 respectively).

14. Device according to any preceding claim, characterized in that the pivoting devices (28, 29) are articulately mounted on the chassis (3) through rear linkages (30, 31) which are centered or substantially centered with a horizontal or substantially horizontal geometric line (21) about which the lifting arms (15, 16) are pivotable.

15. Device according to claim 14, characterized in that the rear linkages (30, 31) are located between the linkages (19, 20) permitting pivoting of the lifting arms (15, 16) in the vertical and horizontal planes (VP15, VP16; HP15, HP16).

16. Device according to any preceding claim, characterized in that the pivoting devices (28, 29) are provided on rear portions (3a) of the chassis (3) through a retaining device (10) on which the linkages (19, 20) for the lifting arms (15, 16) are also provided.

17. Device according to any preceding claim, characterized in that a retaining device (10) for holding the linkages (19, 20) at the chassis (3) comprises two upwardly directed posts (11, 12) and a connecting member (13) connecting the posts, that the posts (11, 12) are provided on opposite sides of rear portions (3a) of the chassis (3) such that a field of view (SB) is defined therebetween in a direction backwards from the driving compartment (2) and that upper parts of the connecting member (13) are located substantially in level with the roof of an operator's cabin (7) provided on the chassis (3).

18. Device according to claim 17, characterized in that the posts (11, 12) are inclined in a backwards/outwards direction relative to a geometric centre line (CL) passing or extending centrally along the chassis (3) and that the posts (11, 12) are inclined relative to said centre line (CL) such that they define the same angle (γ) between them, which limits the field of view (SB) between said posts (11, 12).

19. Device according to any preceding claim, characterized in that each linkage (19 and 20 respectively) for each lifting arm (15 and 16 respectively) comprises a fork like bearing member (19a and 20a respectively) having a horizontal or substantially horizontal shaft (19b and 20b respectively) on which the lifting arm (15 and 16 respectively) is mounted and which permits pivoting thereof in a vertical plane (VP15 and VP16 respectively) and that each fork like bearing member (19a and 20a respectively) by means of a vertical or substantially vertical shaft (19c and 20c respectively) is journalled on the chassis (3) or on a retaining device (10) provided on the chassis (3) such that each lifting arm (15 and 16 respectively) can be pivoted in a horizontal plane (HP15 and HP16 respectively).

20. Device according to any preceding claim, characterized in that the lifting units (22, 23) for pivoting the lifting arms (15, 16) in vertical planes (VP15, VP16) are located between the chassis (3) and the lifting arms (15, 16) behind a vertical plane (VP2) extending through the driving compartment (2) and in transverse direction relative to a geometric centre line (CL) which extends centrally along the chassis (3).

21. Device according to any preceding claim, characterized in that the lifting units (22, 23) for pivoting the lifting arms (15, 16) in vertical planes (VP15, VP16) are articulately connected to the chassis (3) and the lifting arms (15, 16) through lower and upper linkages (24, 25, 26, 27) permitting movements in general.

22. Device according to any preceding claim, characterized in that the lifting units (22, 23) for pivoting the lifting arms (15, 16) in vertical planes (VP15, VP16) are controlled to pivot the lifting arms (15, 16) simultaneously and symmetrically relative to a horizontal plane and that each lifting unit (22 and 23 respectively) is controlled so also bring each lifting arm (15 and 16 respectively) to perform an individual pivoting movement in a vertical plane (VP15 and VP16 respectively) for setting the lifting arms (15, 16) in different height positions relative to each other.

23. Device according to any preceding claim, characterized in that the lifting units (22, 23) for pivoting the lifting arms (15, 16) in vertical planes (VP15, VP16) are located obliquely outside and behind rear edge posts (7a, 7b) to an operator's cabin (7) in which the driving compartment (2) is provided.

24. Device according to any preceding claim, characterized in that front portions (15b, 16b) of the lifting arms (15, 16) are inclined in a forward/outwards direction relative to a geometric centre line (CL) extending centrally along the chassis (3) and that said front portions (15b, 16b) are inclined such that they define substantially the same angle (β) between them as a field of view (SF1) between said front portions (15b, 16b), preferably when the lifting arms (15, 16) are situated in such intermediate positions (N) relative to each other in which they are directed in parallel or substantially in parallel with said centre line (CL).

25. Device according to any preceding claim, characterized in that each lifting arm (15 and 16 respectively) comprises rear portions (15a and 16a respectively) which in a lower position (L) extend horizontally or substantially horizontally and that each lifting arm (15 and 16 respectively) comprises front portions (15b and 16b respectively) which are arcuate and downwardly directed and of which lower parts (15c and 16c respectively) in a lower position (L) are located in front of front portions (3a) of the chassis (3).

26. Device according to any preceding claim, characterized in that the lifting arms (15, 16) are telescopic such that their length can be varied and that power units (34, 35) are provided to change the length of the lifting arms (15, 16) and maintain the length set after the change.

27. Device according to claim 26, characterized in that said power units (34, 35) are operated or controlled to change or alter the length of the lifting arms (15, 16) at the same time and to the same extent and that the power units (34, 35) are individually controlled to change the length of only one lifting arm (15 or 16) and not of the other or to change the length of the two lifting arms (15, 16) differently.

28. Device according to any preceding claim, characterized in that a lifting means (17, 18) in the form of a lift fork is provided on front portions (15b, 16b), preferably on lower parts (15c, 16c) of said front portions (15b, 16b) of each lifting arm (15 and 16 respectively).

29. Device according to claim 28, characterized in that first pivoting units (37, 38) are provided to pivot the lifting means (17, 18) to such positions relative to the lifting arms (15, 16) that fork blades (17b, 18b) forming part of the lifting means (17, 18) are set in horizontal positions or positions which are inclined relative to said horizontal positions.

30. Device according to claim 29, characterized in that the first pivoting units (37, 38) are operated or controlled to pivot the lifting means (17, 18) simultaneously and such that their fork blades (17b, 18b) are set in positions corresponding to each other and that said first pivoting units (37, 38) are controlled to pivot the lifting means (17, 18) individually for changing position of one lifting means (17 or 18) only and thereby the angular position of one fork blade (17b or 18b) only, or pivot the lifting means (17, 18) differently for locating the fork blades (17b, 18b) in different positions relative to the horizontal plane.

31. Device according to any preceding claim, characterized in that second pivoting units (39, 40) are provided to pivot the lifting means (17, 18) to such positions relative to the lifting arms (15, 16) that the fork blades (17b, 18b) change their angular positions relative to a geometric line (CL) extending centrally through the chassis (3).

32. Device according to claim 31, characterized in that the second pivoting units (39, 40) are operated or controlled to pivot the lifting means (17, 18) simultaneously and such that their fork blades (17b, 18b) define or make the same angles with the centre line (CL) and that the second pivoting units (39, 40) are operated or controlled to pivot the lifting means (17, 18) individually for changing the angular position of one of the fork blades (17b or 18b) only relative to said centre line (CL) or change the positions of the fork blades (17b, 18b) such that they are set in different angular positions relative to the centre line (CL).

33. Device according to any preceding claim, characterized in that a lifting means (17, 18) in the form of a fetching means, e.g. for fetching bales, rolls or plates, is provided on front portions (15b, 16b), preferably on lower parts (15c, 16c) of said front portions (15b, 16b) of each lifting arm (15 and 16 respectively).

34. Device according to claim 33, characterized in that a clamping device for clamping or gripping goods between the fetching arms such that said goods can be lifted is provided between the fetching arms.

35. Device according to any preceding claim, characterized in that the lifting arms (15, 16) and a retaining device (10) located behind the driving compartment (2) for retaining said lifting arms (15, 16) at the chassis (3), replace vertical beams located in front of the driving compartment (2) and a lifting carriage provided on said beams.
